(19) United States
(12) Patent Application Publication
(10) Pub. No.: US 2006/0200485 A1
(43) Pub. Date: Sep. 7, 2006

(54) Database instance management system and method

(75) Inventors: Scott D. Hicks, Underhill Center, VT (US); James A. Martin JR., Endicott, NY (US); Douglas G. Murray, Johnson City, NY (US); Diane C. Rauch, Williston, VT (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/074,881

(22) Filed: Mar. 7, 2005

(51) Int. Cl. G06F 7/00

(52) U.S. Cl. 707/102

(57) ABSTRACT

A system, method and program product for managing database instances. A computer system is disclosed that includes a system for inputting a request for a new database instance; a system for verifying the request; a system for creating the database instance; and a system for configuring the database instance.

### BACKGROUND OF THE INVENTION

1. Technical Field

The present invention relates generally to database management, and more specifically relates to a process for creating on-demand database instances for large scale projects.

2. Related Art

Many large scale projects, such as enterprise-wide information technology (IT) migrations, utilize databases to help manage processes such as progress reports, billing, workflow, etc. If the project is large enough, a single database may prove to be unwieldy, e.g., requiring the management of data from many different sites within an organization, requiring the management of data from a series of sub-projects, etc.

One way to address the problem is to maintain a single database design and create instances of the database “on demand” as required during the execution of the project. In this way, data can be managed using the same database rules and processes by different groups or at different times throughout the organization. For instance, one site within the organization may be involved in a first phase of the project and require the database in January, while a second site may be involved in a second phase, and not require use of the database until June. In this case, providing the database for the second site before June would be a waste of time and resources.

Unfortunately, without a standardized approach to creating database instances, the process of providing on-demand database instances to address the above need would not only be costly, but would also be wrought with potential errors. Accordingly, a need exists for a standardized process of creating database instances.

### SUMMARY OF THE INVENTION

The present invention addresses the above-mentioned problems, as well as others, by providing a database instance management system for efficiently creating database instances in accordance with on-demand requests, thus allowing just in time instances to be created in a standardized way. Accordingly, any necessary data processing agents are not enabled until they are needed, and any data preloads are not initiated until needed.

In a first aspect, the invention provides a computer system having a database instance management system, comprising: a system for inputting a request for a new database instance; a system for verifying the request; a system for creating the database instance; and a system for configuring the database instance.

In a second aspect, the invention provides a method for managing database instances, comprising: receiving a request for a new database instance into a database instance management system; verifying the request; using the database instance management system to automatically create the database instance; and using the database instance management system to automatically configure the database instance.

In a third aspect, the invention provides a program product stored on a computer readable medium for managing database instances, comprising: program code configured for receiving a request for a new database instance; program code configured for verifying the request; program code configured for creating the database instance; and program code configured for configuring the database instance.

In a fourth aspect, the invention provides a method for deploying an application for managing database instances, comprising: providing a computer infrastructure being operable to: receive a request for a new database instance; verify the request; create the database instance; and configure the database instance.

In a fifth aspect, the invention provides computer software embodied in a propagated signal for managing database instances, the computer software comprising instructions to cause a computer to perform the following functions: receiving a request for a new database instance; verifying the request; creating the database instance; and configuring the database instance.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a database instance management system in accordance with the present invention.

FIG. 2 depicts a screen interface view showing a list of created database instances.

FIG. 3 depicts a flow chart showing the steps involved in providing a new database instance in accordance with the present invention.

FIG. 4 depicts a screen interface view for creating a new database within the database instance management system of FIG. 1.

FIG. 5 depicts a screen interface view for administering access control lists within the database instance management system of FIG. 1.

FIG. 6 depicts a screen interface view for administering agent control files within the database instance management system of FIG. 1.

### DETAILED DESCRIPTION OF THE INVENTION

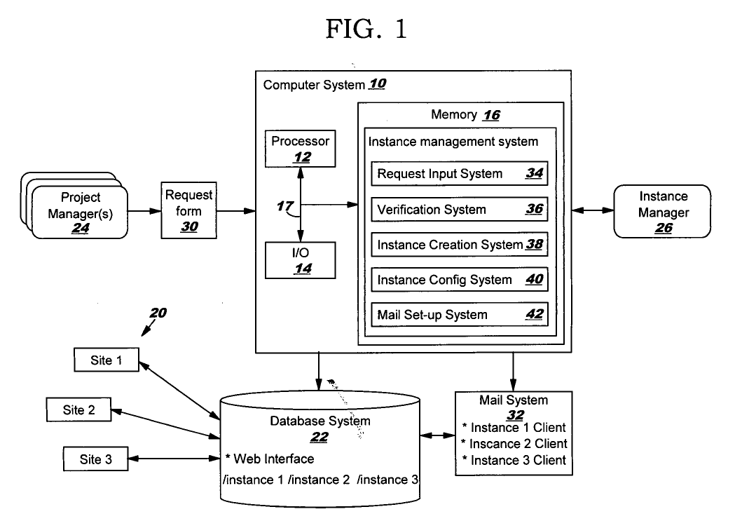

Referring now to the drawings, FIG. 1 depicts a computer system 10 having a database instance management system 18 for managing the process of creating, implementing, and maintaining database instances. Database management system 18 may be implemented as a software tool that includes different views or screens for managing the different steps involved in the process.

In general, computer system 10 may comprise, e.g., a desktop, a laptop, a workstation, etc. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

As described in further detail below, instances are created and stored in database system 22. Database system 22 may be implemented a separate computer system and may comprise any type of database application that includes one or more storage devices, such as RAM, ROM, a magnetic disk drive and/or an optical disk drive. Data storage could also be distributed across, for example, a local area network (LAN), wide area network (WAN) or a storage area network (SAN) (not shown). Mail system 32 may likewise be implemented on a computer system and include any email clients created for each of the database instances. Mail system 32 may be implemented separately from, or be integrated into, database system 22.

Access to computer system 10, database system 22, and mail system 32 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

As noted above, instance management system 18 includes various mechanisms for managing and automating the process of creating new database instances. These mechanisms generally include a request input system 34, a verification system 36, an instance creation system 38, an instance configuration system 40, and a mail set-up system 42.

The process of creating a new database instance begins when a project manager 24 (or the like) submits a request form 30 to the instance management system 18. The request form 30 includes any information required to set up the instance, such as a project manager ID, supported locations, IDs for different team members who will be using the database, individuals such as administrators that may have different privileges, external resource information such as printers, parameters relevant for the database such as billing codes and workgroup information, etc. The request form 30 may be submitted in any manner, e.g., as an email, as an on-line form, etc.

After instance management system 18 captures the details from the request form 30, an instance manager 26 may verify the request form 30 using verification system 36. Instance manager 26 may typically be the person overseeing the database instance management system 18. Instance manager 26 could also be implemented as a programmable agent or the like that controls instance management system 18 in an automated fashion. Verification system 36 may be implemented in any manner. For instance, it may simply display the details in the request form 30 for review by the instance manager 26. Alternatively, verification system 36 may programmatically audit the data in the request form 30 to ensure compliance.

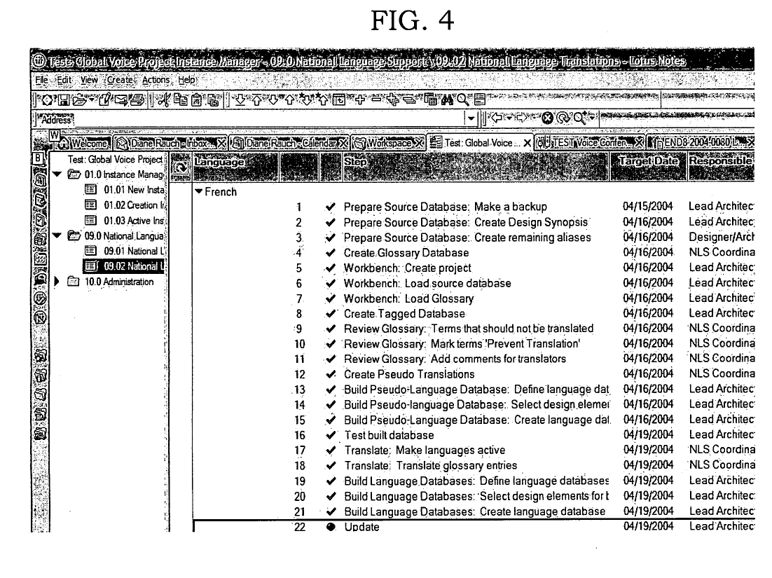

After verification, data instance creation system 38 creates a new instance based on an existing database schema, and stores the new instance within database system 22. Data instance configuration system 40 is then utilized to configure the new instance. The creation and configuration processes can likewise be implemented in any manner. For instance, the creation process may be implemented as a series of automated and/or manual steps, such as those shown in FIG. 4. Configuration may for example be implemented as a set of steps that include creating and configuring access control list (ACL) groups, creating an FTP site, creating initialization files, and creating agent control files. Finally, mail set-up system 42 is utilized to implement an email client for the new instance within mail system 32, which may include creating a mailer database; populating the mailer with approved communications; and activating the mail processing.

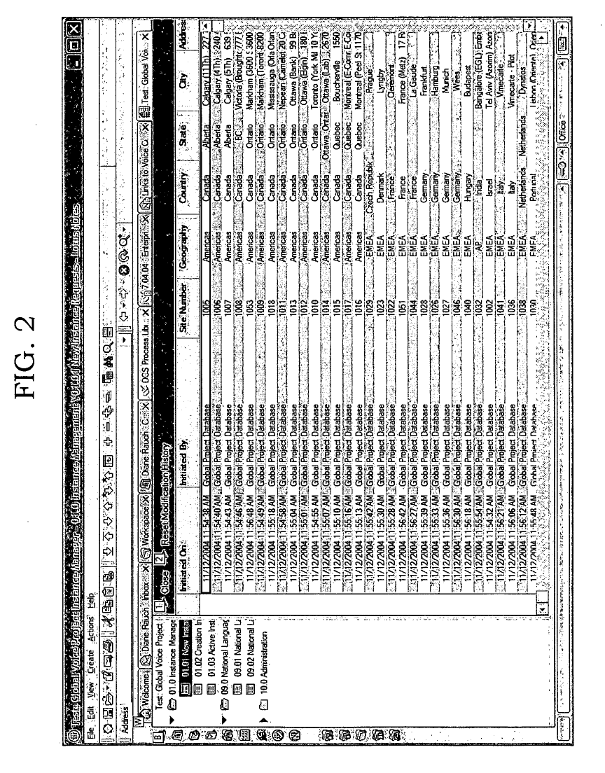

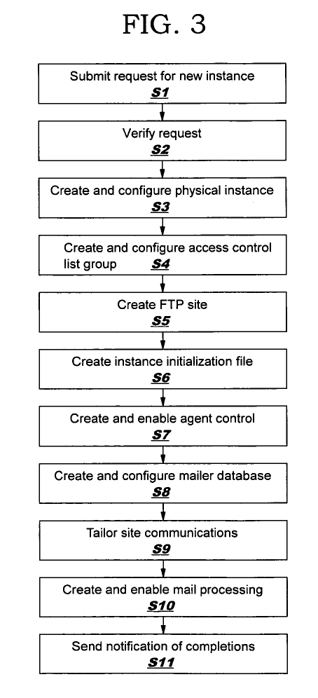

Each different site 20 can then access their particular database instance from database system 22, e.g., via a web interface, as well as their email client from the mail system 32. FIG. 2 depicts an illustrative view provided by the instance management system 18 showing a list of sites that had a database instance created for a particular project within an organization. From this view, the instance manager 26 is able to create, manage and administer database instances. FIG. 3 depicts a flow chart showing the process in further detail. In the first step S1, a request is submitted for a new instance. As noted above, this may be accomplished by a project manager 24 filling out a request form 30. In the second step, S2, the request form is verified by the instance manager 26. In step S3, a physical database instance is created and configured. FIG. 4 depicts an illustrative interface that allows the instance manager 26 to create a new instance. In the example shown in FIG. 4, the instance manager would select the 01.01 and 01.02 tabs in the left window to select a location and create the instance, which would in turn automate the implementation of a number of steps shown in the main window. Each step is given a check mark after it has been successfully completed. The steps involved may vary depending on the particular implementation, and may include both automated and manual processes.

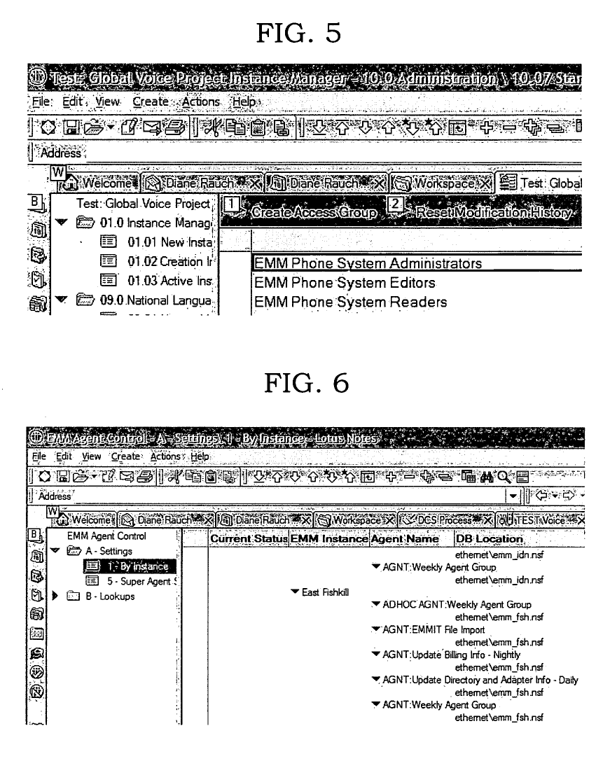

Next, at step S4, access control list (ACL) groups are created and configured. This grants different privilege levels to different groups such as administrators, editors, readers, etc. An example of this is shown in FIG. 5, where for instance one or more ACL groups are listed (such as “EMM Phone System Administrators”). ACL groups can by created by clicking the “Create Access Group” button, which would bring up a create and configure window (not shown) in which the instance manager 26 could name and set up a new ACL group. In step S5, the instance manager may create a specific FTP site for the new instance. At step S6, an instance initialization file may be created for the instance, which would be added to a universal web interface. At step S7, agent control- files are created and enabled. Specific agents are created and scheduled for the data instance, e.g., a billing agent might be implemented to download data at a specific time of day. An illustrative interface for this process is shown in FIG. 6, in which new agents can be created for an instance. In this example, the instance “East Fishkill” lists several agents such as “AGNT:EMMIT File Import,” which performs a file import process. Clicking on a listed agent will bring up a detail window (not shown) for the agent, in which the agent can be activated and configured.

At step S8, a mailer database is created and configured and at step S9, site communications are tailored. The tailoring process may involve the instance manager 26 populating the mailer with approved communications. An approved communication might include an initial email to all individuals having IDs that can access the database instance requesting that a utility be run on their system to inventory hardware information. At step S10, mail processing is created and enabled. This process maybe done as a dedicated client on a separate mail system 32. Finally, at step S11, a notification is generated and sent to the project manager 24 indicating that the database instance is complete. Included in the notification are the links to the new instance and mailer.

It should be appreciated that the teachings of the present invention could be offered as a business method on a subscription or fee basis. For example, a computer system 10 comprising instance management system 18 could be created, maintained and/or deployed by a service provider that offers the functions described herein for customers. That is, a service provider could offer to create and manage database instances as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computer system having a database instance management system, comprising:
a system for inputting a request for a new database instance;
a system for verifying the request;
a system for creating the database instance; and
a system for configuring the database instance.

2. The computer system of claim 1, further comprising a system for setting up a mail system to be utilized in conjunction with the database instance.

3. The computer system of claim 2, wherein the system for setting up the mail system includes:
creating a mailer database;
populating the mailer with approved communications; and
activating the mail processing.

4. The computer system of claim 1, wherein the system for configuring the database includes creating and configuring access control list groups.

5. The computer system of claim 1, wherein the system for configuring the database includes creating, scheduling and enabling agents.

6. The computer system of claim 1, wherein the request comprises an email form that includes IDs of individuals that will be utilizing the database instance.

7. The computer system of claim 1, further comprising a system for viewing a plurality of different database instances created by the database instance management system.

8. A method for managing database instances, comprising:
receiving a request for a new database instance into a database instance management system;
verifying the request;
using the database instance management system to automatically create the database instance; and
using the database instance management system to automatically configure the database instance.

9. The method of claim 8, further comprising the step of using the database instance management system to automatically setting up a mail system to be utilized in conjunction with the database instance.

10. The method of claim 9, wherein the step of setting up the mail system includes:
creating a mailer database;
populating the mailer with approved communications; and
activating the mail processing.

11. The method of claim 8, wherein the request comprises an email form that includes IDs of individuals that will be utilizing the database instance.

12. The method of claim 8, wherein the step of configuring the database includes creating and configuring access control list groups.

13. The method of claim 8, wherein the step of configuring the database includes creating, scheduling and enabling agents.

14. A program product stored on a computer readable medium for managing database instances, comprising:
program code configured for receiving a request for a new database instance;
program code configured for verifying the request;
program code configured for creating the database instance; and
program code configured for configuring the database instance.

15. The program product of claim 14, further comprising program code configured for setting up a mail system to be utilized in conjunction with the database instance.

16. The program product of claim 15, wherein the program code configured for setting up the mail system includes:
program code configured for creating a mailer database;
program code configured for populating the mailer with approved communications; and
program code configured for activating the mail processing.

17. The program product of claim 14, wherein the program code configured for configuring the database includes creating and configuring access control list groups.

18. The program product of claim 14, wherein the program code configured for configuring the database includes creating, scheduling and enabling agents.

19. The program product of claim 14, wherein the request comprises an email form that includes IDs of individuals that will be utilizing the database instance.

20. The program product of claim 14, further comprising program code configured for viewing a plurality of different database instances created by the program product.

21. A method for deploying an application for managing database instances, comprising:
providing a computer infrastructure being operable to:
receive a request for a new database instance;
verify the request;
create the database instance; and
configure the database instance.

22. Computer software embodied in a propagated signal for managing database instances, the computer software comprising instructions to cause a computer to perform the following functions:
receiving a request for a new database instance;
verifying the request;
creating the database instance; and
configuring the database instance.
